(19) United States
(12) Patent Application Publication
(10) Pub. No.: US 2021/0383468 A1
(43) Pub. Date: Dec. 9, 2021

(54) DISTRIBUTED LEDGER TECHNOLOGY AND ARTIFICIAL INTELLIGENCE-BASED ENERGY TRADING

(71) Applicant: ACCENTURE GLOBAL SOLUTIONS LIMITED, Dublin (IE)

(72) Inventors: Abdoulaye FAYE, Valbonne (FR); Giuseppe GIORDANO, Antibes (FR); Haris PASIC, Biot (FR); Luca SCHIATTI, Juan les pins (FR); Giuseppe RIZZO, Torino (IT); Alfredo FAVENZA, Torino (IT); Alberto BENINCASA, Torino (IT); Alberto BUZIO, Torino (IT)

(73) Assignee: ACCENTURE GLOBAL SOLUTIONS LIMITED, Dublin (IE)

(21) Appl. No.: 16/917,532

(22) Filed: Jun. 30, 2020

(30) Foreign Application Priority Data
Jun. 4, 2020 (EP) 20305589.2

(51) Int. Cl. G06Q 40/04; G06Q 50/06; G06Q 10/04; G06F 16/23; G06N 20/00; G06N 5/04

(52) U.S. Cl. CPC G06Q 40/04; G06Q 50/06; G06N 5/04; G06F 16/2379; G06N 20/00; G06Q 10/04

(57) ABSTRACT

In some examples, distributed ledger technology and artificial intelligence-based energy trading may include ascertaining energy data that includes historical weather data for a plurality of units, future climate forecast data, household behavioral energy data, and distributed ledger technology energy marketplace data. Based on a specified time interval, a specified future time duration may be divided to generate a plurality of specified divided future time durations to determine a price of energy. A trading recommendation may be generated for a time during the specified future time duration to buy the energy from a distributed ledger technology energy marketplace, and/or another time during the specified future time duration to sell the energy to the distributed ledger technology energy marketplace. Further, instructions to implement the recommendation may be generated to buy the energy and/or sell the energy.

### BACKGROUND

Commodities, such as energy, may be bought and sold by traders. For example, an energy trader on a demand side of the energy may buy energy from an energy supplier when a price of the energy is acceptable to match availability of the energy by different energy suppliers, and a demand by energy consumers. Another energy trader on a supply side of the energy may sell the energy to energy consumers based on similar factors.

### BRIEF DESCRIPTION OF DRAWINGS

Features of the present disclosure are illustrated by way of example and not limited in the following figure(s), in which like numerals indicate like elements, in which:

FIG. 1 illustrates a layout of a distributed ledger technology (DLT) and artificial intelligence-based energy trading apparatus in accordance with an example of the present disclosure;

FIG. 2 illustrates an energy trading layout to illustrate operation of the distributed ledger technology and artificial intelligence-based energy trading apparatus of FIG. 1 in accordance with an example of the present disclosure;

FIG. 3 illustrates a data source example to illustrate operation of the distributed ledger technology and artificial intelligence-based energy trading apparatus of FIG. 1 in accordance with an example of the present disclosure;

FIG. 4 illustrates a logical flow of the distributed ledger technology and artificial intelligence-based energy trading apparatus of FIG. 1 in accordance with an example of the present disclosure;

FIG. 5 illustrates a distributed ledger technology solidity smart contract model to illustrate operation of the distributed ledger technology and artificial intelligence-based energy trading apparatus of FIG. 1 in accordance with an example of the present disclosure;

FIG. 6 illustrates the dataset division in a training set and a test set utilized for training the deep learning energy price forecaster of the distributed ledger technology and artificial intelligence-based energy trading apparatus of FIG. 1 in accordance with an example of the present disclosure;

FIG. 7 illustrates a deep learning technique for electricity price forecasting (EPF) to illustrate operation of the distributed ledger technology and artificial intelligence-based energy trading apparatus of FIG. 1 in accordance with an example of the present disclosure;

FIG. 8 illustrates execution of the deep learning technique over two time steps of a given time series for electricity price forecasting to illustrate operation of the distributed ledger technology and artificial intelligence-based energy trading apparatus of FIG. 1 in accordance with an example of the present disclosure;

FIG. 9 illustrates a long short-term memory (LSTM) cell for the distributed ledger technology and artificial intelligence-based energy trading apparatus of FIG. 1 in accordance with an example of the present disclosure;

FIG. 10 illustrates a linear layer for the distributed ledger technology and artificial intelligence-based energy trading apparatus of FIG. 1 in accordance with an example of the present disclosure;

FIG. 11 illustrates electricity price forecasting validation results to illustrate operation of the distributed ledger technology and artificial intelligence-based energy trading apparatus of FIG. 1 in accordance with an example of the present disclosure;

FIG. 12 illustrates trading recommendations to illustrate operation of the distributed ledger technology and artificial intelligence-based energy trading apparatus of FIG. 1 in accordance with an example of the present disclosure;

FIG. 13 illustrates buy and sell recommendations to illustrate operation of the distributed ledger technology and artificial intelligence-based energy trading apparatus of FIG. 1 in accordance with an example of the present disclosure;

FIG. 14 illustrates correlation between data quantity and performance to illustrate operation of the distributed ledger technology and artificial intelligence-based energy trading apparatus of FIG. 1 in accordance with an example of the present disclosure;

FIG. 15 illustrates an example block diagram for distributed ledger technology and artificial intelligence-based energy trading in accordance with an example of the present disclosure;

FIG. 16 illustrates a flowchart of an example method for distributed ledger technology and artificial intelligence-based energy trading in accordance with an example of the present disclosure; and

FIG. 17 illustrates a further example block diagram for distributed ledger technology and artificial intelligence-based energy trading in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Distributed ledger technology and artificial intelligence-based energy trading apparatuses, methods for distributed ledger technology and artificial intelligence-based energy trading, and non-transitory computer readable media having stored thereon machine readable instructions to provide distributed ledger technology and artificial intelligence-based energy trading are disclosed herein. The apparatuses, methods, and non-transitory computer readable media disclosed herein provide for distributed ledger technology and artificial intelligence-based energy trading by utilizing artificial intelligence to learn from historical transactions stored in a ledger, and optimizing the margin for energy trading. In this regard, by utilizing artificial intelligence, a trader may understand what is the best time to buy and sell energy. For the apparatuses, methods, and non-transitory computer readable media disclosed herein, the guided energy trading may also improve the optimization of the energy grid by avoiding losses of surplus energy generated by prosumers.

With respect to energy trading generally, peer to peer energy trading is emerging as a viable energy model in the light of significant changes occurring in the energy industry. For example, the rise of electric vehicles, smart energy storage, and lower prices of solar technology may drive changes in the energy industry. With the introduction of the blockchain concept, traders may directly trade energy. For example, traders may buy energy as a surplus of energy produced by prosumers, and resell the energy to an energy grid for a different price. In this manner, traders may benefit from the proliferation of batteries that provide storage of energy, and re-inject the stored energy into the energy grid at a convenient time. However, in this regard, it is technically challenging to determine a best time to buy and sell the energy. It is also technically challenging to manage surplus energy generated by prosumers to avoid losses of such surplus energy.

The apparatuses, methods, and non-transitory computer readable media disclosed herein address at least the aforementioned technical challenges by utilizing blockchain data to feed an artificial intelligence system to determine when to buy and sell energy, as well as to manage surplus energy generated by prosumers.

For the apparatuses, methods, and non-transitory computer readable media disclosed herein, for traders that buy energy from a household and sell the energy back to an energy provider, according to examples disclosed herein, the households may include solar panels to generate energy. The traders made by surplus energy from households according to a price defined by the market. The traders may each have access to an energy storage battery to store energy that is brought from the households. The traders may re-sell the energy to an energy provider. Alternatively or additionally, a trader may sell the energy directly to another household. An artificial intelligence-based energy price forecaster as disclosed herein may learn from historical transactions and weather conditions. Further, the artificial intelligence-based energy price forecaster may recommend the best moment to buy and the best moment to sell the energy. In this regard, a recommendation to buy or sell may be made independent of a storage capacity associated with a trader. A distributed ledger technology energy marketplace that may serve as the platform but buying and selling the energy as disclosed herein may not be directly connected to the energy grid, and may digitally represent the energy offers and buy/sell agreements between participants.

The apparatuses, methods, and non-transitory computer readable media disclosed herein may thus utilize artificial intelligence and blockchain technology to learn from blockchain transactions. A trader may buy, at the distributed ledger technology energy marketplace, energy surplus from a household, and similarly, a household may buy, at the distributed ledger technology energy marketplace, energy from an energy provider. In this manner, the apparatuses, methods, and non-transitory computer readable media disclosed herein may provide the technical benefit of minimizing losses of surplus energy generated by prosumers (e.g., the households as disclosed herein). The apparatuses, methods, and non-transitory computer readable media disclosed herein may also provide the technical benefit of automating (e.g., performing without human intervention), via a trading controller, the process of buying and selling energy at the recommended time(s) to buy and sell the energy.

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

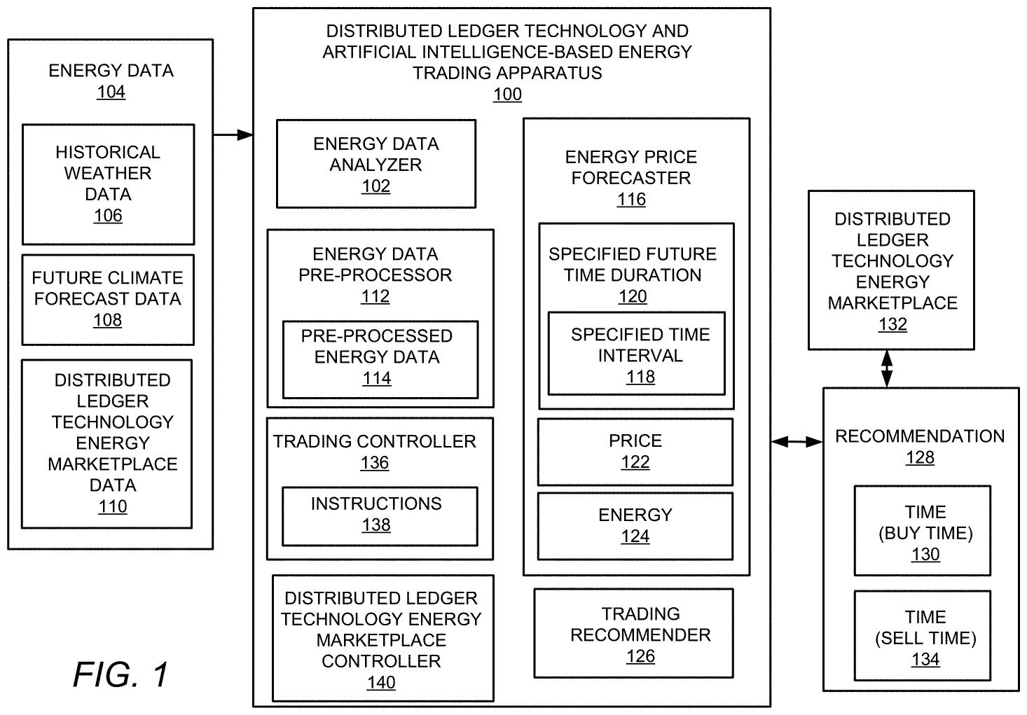

FIG. 1 illustrates a layout of an example distributed ledger technology and artificial intelligence-based energy trading apparatus (hereinafter also referred to as “apparatus 100”).

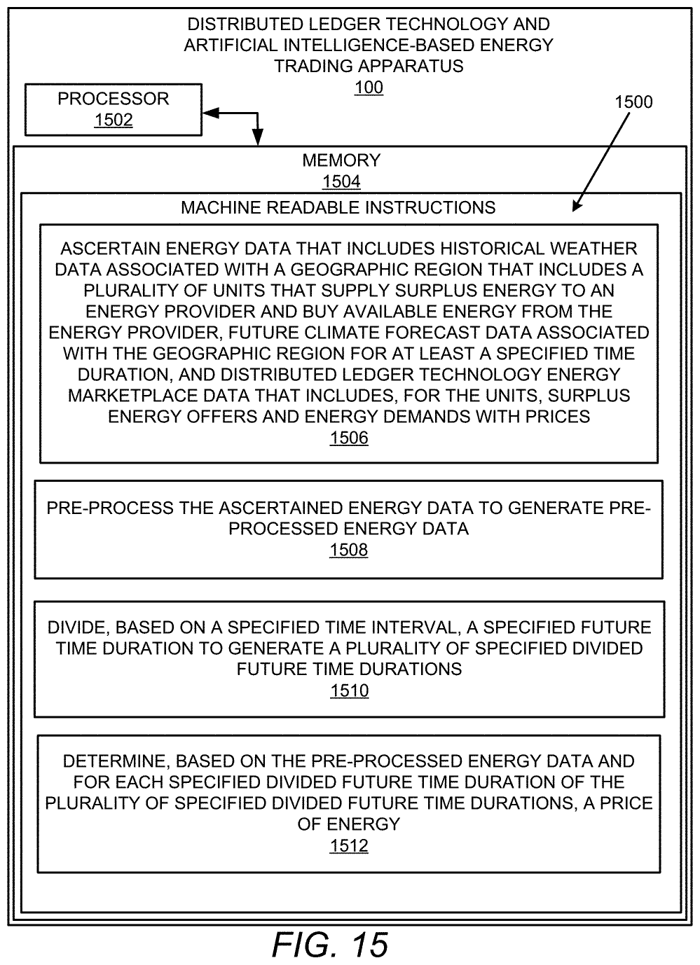

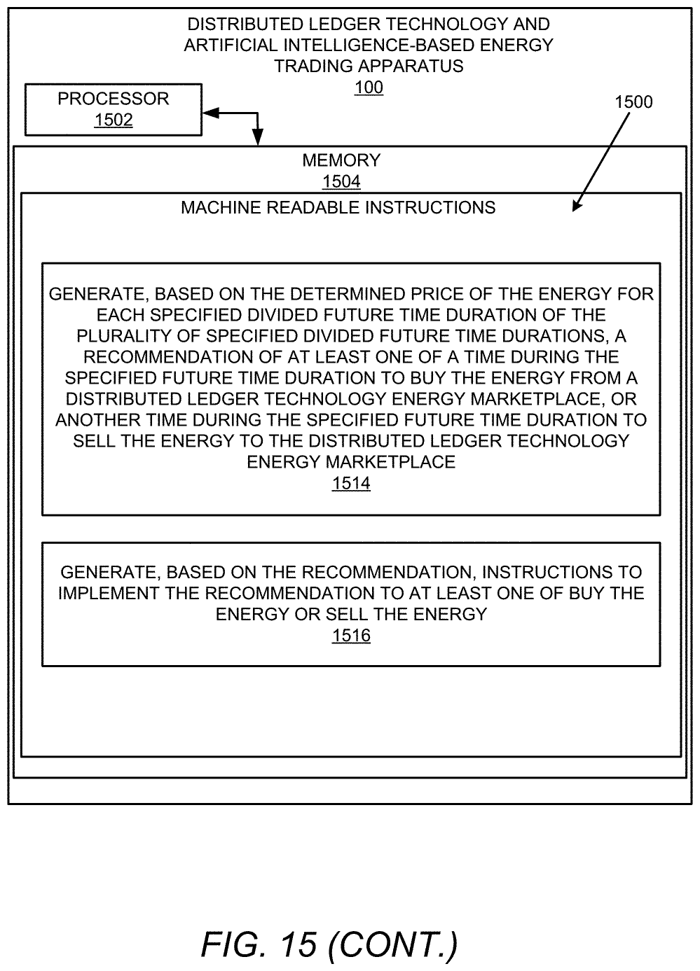

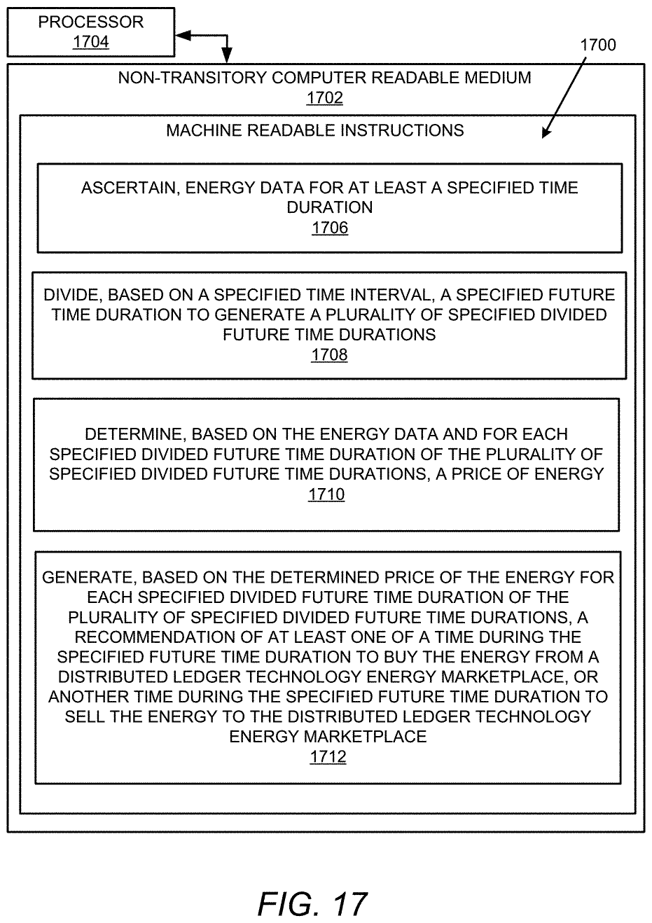

Referring to FIG. 1, the apparatus 100 may include an energy data analyzer 102 that is executed by at least one hardware processor (e.g., the hardware processor 1502 of FIG. 15, and/or the hardware processor 1704 of FIG. 17) to ascertain energy data 104. For example, the energy data 104 may include historical weather data 106 associated with a geographic region that includes a plurality of units that supply surplus energy to an energy provider and buy available energy from the energy provider. The energy data 104 may further include future climate forecast data 108 associated with the geographic region for at least a specified time duration. Further, the energy data 104 may include, for the units, distributed ledger technology energy marketplace data 110 that includes surplus energy offers and energy demands with prices.

An energy data pre-processor 112 that is executed by at least one hardware processor (e.g., the hardware processor 1502 of FIG. 15, and/or the hardware processor 1704 of FIG. 17) may pre-process the ascertained energy data 104 to generate pre-processed energy data 114.

An energy price forecaster 116 that is executed by at least one hardware processor (e.g., the hardware processor 1502 of FIG. 15, and/or the hardware processor 1704 of FIG. 17) may divide, based on a specified time interval 118, a specified future time duration 120 to generate a plurality of specified divided future time durations. The energy price forecaster 116 may determine, based on the pre-processed energy data 114 and for each specified divided future time duration of the plurality of specified divided future time durations, a price 122 of energy 124. In this regard, the energy price forecaster 116 may be trained, for example, by using the pre-processed energy data 114 as disclosed herein. Once the energy price forecaster 116 is trained, the trained energy price forecaster 116 may be used to predict the price of energy for the specified future time duration.

A trading recommender 126 that is executed by at least one hardware processor (e.g., the hardware processor 1502 of FIG. 15, and/or the hardware processor 1704 of FIG. 17) may generate, based on the determined price 122 of the energy 124 for each specified divided future time duration of the plurality of specified divided future time durations, a recommendation 128 of a time 130 (e.g., a buy time) during the specified future time duration to buy the energy 124 from a distributed ledger technology energy marketplace 132 and/or another time 134 (e.g., a sell time) during the specified future time duration 120 to sell the energy 124 to the distributed ledger technology energy marketplace 132.

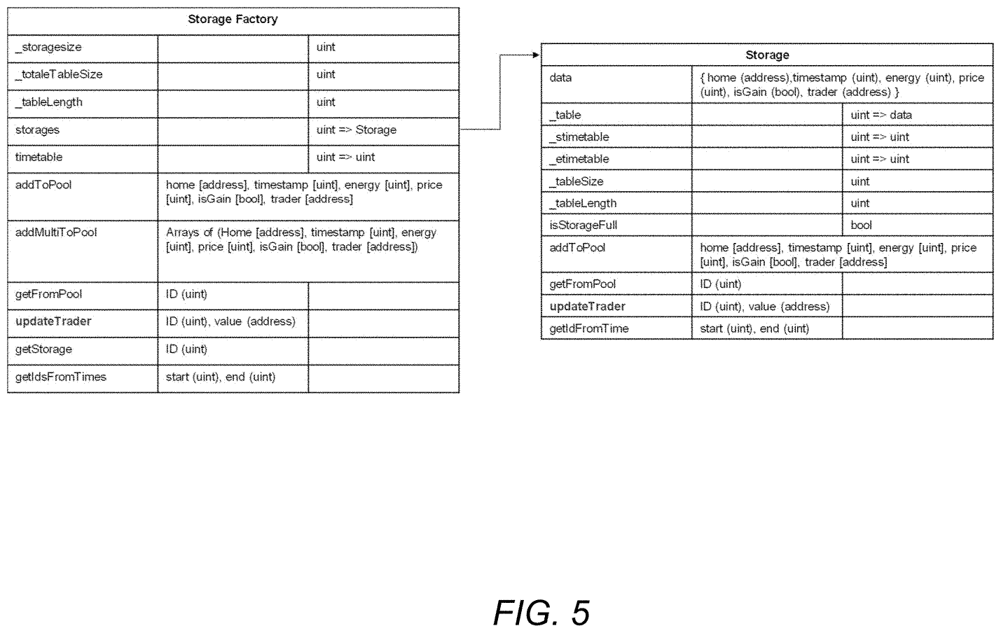

A trading controller 136 that is executed by at least one hardware processor (e.g., the hardware processor 1502 of FIG. 15, and/or the hardware processor 1704 of FIG. 17) may generate, based on the recommendation 128, instructions 138 to implement the recommendation 128 to buy the energy 124 or sell the energy 124. The buy energy instructions may include querying the distributed ledger technology energy marketplace 132 status, and all of the available offers may be returned. All of the offers that do not have a buyer assigned (e.g., trader field in data field of the storage table described in FIG. 5) may represent open offers that may be in the transaction by including a coin system in the distributed ledger technology energy marketplace 132, or may be payed via other channels (e.g., credit, bank account, etc.) according the transactions recorded in the smart contract tables of FIG. 5. For the logical representation of the smart contract tables of FIG. 5, the tables may be connected with the storage field. A smart contract may be composed by a data structure and functions (e.g., code) that is the same for all the participants to the network. A blockchain may include a list of transactions (some of which are calls to functions of a smart contract to update the data value). The functions may be designed to run in a decentralized system. When one actor calls, a function in the blockchain may be recorded as an “Actor address” function called with parameters. Every actor connected on the blockchain may run the function and update their local view of the data. The smart contract may be used to define the data and functions, and may be used by actors to call a function and update data (e.g. traders call function UpdateTrader to buy energy—the function will update the data by assigning to the trader a certain offer). FIG. 5 describes a structure to perform contract paging, where “Storage Factory” is the main table that initiates the “Storage” contract when a contract maximum size is reached (where a limited number of data lines may be inserted).

The actual exchange of energy may be recorded via smart meters connected to the distributed ledger technology energy marketplace 132, as disclosed, for example, in EP3193299A1, titled “Device, method and system for autonomous selection of a commodity supplier through a blockchain distributed database”.

The trading controller 136 may implement selling of energy by sending a new transaction to the distributed ledger technology energy marketplace 132. For example, a new transaction may be signed and published in the distributed ledger technology energy marketplace 132 by adding a new line in the structure defined in FIG. 5 with the amount of energy that is to be sold in the distributed ledger technology energy marketplace 132. The offers may be recorded as a list of offers (table with data field in FIG. 5 in the storage contract). As an example a new offer may look like the following (new line in the table):

Addreshome:0x1234;timestamp:
20190207000744, energy:1234,price:1234,isGain:false, trader:null
IF a trader is null it means that no one bought that energy unit. The trader may send a transaction calling “updateTrader” and the line will be updated as follows: Addreshome:0x1234;timestamp:
20190207000744, energy:1234,price:1234,isGain:false, trader:0x3455
The smart contract logic may enforce the fact that once the trader bought energy the field “trader” cannot be updated anymore.

A distributed ledger technology energy marketplace controller 140 that is executed by at least one hardware processor (e.g., the hardware processor 1502 of FIG. 15, and/or the hardware processor 1704 of FIG. 17) may update, based on the instructions 138 to implement the recommendation 128 to buy the energy 124 or sell the energy 124, the distributed ledger technology energy marketplace 132 to include, in the distributed ledger technology energy marketplace data 110, an amount of the energy 124 (e.g., that is bought or sold), and the price of the energy 124.

According to examples disclosed herein, the energy data analyzer 102 may ascertain energy data 104 that includes historical weather data associated with the geographic region that includes the plurality of units that supply surplus energy to the energy provider and buy available energy from the energy provider by ascertaining energy data 104 that includes historical weather data associated with the geographic region that includes the plurality of units that each include a household.

According to examples disclosed herein, the energy price forecaster 116 may determine, based on the pre-processed energy data 114 and for each specified divided future time duration of the plurality of specified divided future time durations, the price 122 of energy 124 by receiving, by a long short-term memory cell, the price of the energy 124 at a specified time. The energy price forecaster 116 may determine, by the long short-term memory cell and based on the price of the energy 124 at the specified time, an embedding vector of price trend features at the specified time. Further, the energy price forecaster 116 may determine, based on the embedding vector of price trend features at the specified time, an estimate of the price 122 of the energy 124 at another specified time during the specified future time duration 120.

According to examples disclosed herein, the energy price forecaster 116 may determine, based on the pre-processed energy data 114 and for each specified divided future time duration of the plurality of specified divided future time durations, the price 122 of energy 124 by receiving, by a linear layer, behavior features for each of the units at the specified time. The energy price forecaster 116 may determine, by the linear layer and based on the behavior features for each of the units at the specified time, an embedding vector of behaviors at the specified time. The energy price forecaster 116 may determine, based on the embedding vector of price trend features at the specified time and the embedding vector of behaviors at the specified time, the estimate of the price 122 of the energy 124 at the another specified time during the specified future time duration 120.

According to examples disclosed herein, the energy price forecaster 116 may determine, based on the pre-processed energy data and for each specified divided future time duration of the plurality of specified divided future time durations, the price 122 of energy 124 by receiving, by a further linear layer, external features for each of the units at the specified time. The external features may include, for example, seasonality, rainfall, and/or solar exposure. The energy price forecaster 116 may determine, based on the further linear layer, and based on the embedding vector of price trend features at the specified time and the embedding vector of behaviors at the specified time, the estimate of the price 122 of the energy 124 at the another specified time during the specified future time duration 120.

According to examples disclosed herein, the trading recommender 126 may generate, based on the determined price 122 of the energy 124 for each specified divided future time duration of the plurality of specified divided future time durations, the recommendation 128 by determining, for the price 122 of energy 124 determined at each specified divided future time duration of the plurality of specified divided future time durations, a specified divided future time duration for which the price 122 of energy 124 is minimum. Further, the trading recommender 126 may generate, for the specified divided future time duration for which the price 122 of energy 124 is minimum, the recommendation 128 of the time during the specified future time duration 120 to buy the energy 124 from the distributed ledger technology energy marketplace 132.

According to examples disclosed herein, the trading recommender 126 may generate, based on the determined price 122 of the energy 124 for each specified divided future time duration of the plurality of specified divided future time durations, the recommendation 128 by determining, for the price 122 of energy 124 determined at each specified divided future time duration of the plurality of specified divided future time durations, a specified divided future time duration for which the price 122 of energy 124 is minimum and at least one energy offer is available in the distributed ledger technology energy marketplace 132. Further, the trading recommender 126 may generate, for the specified divided future time duration for which the price 122 of energy 124 is minimum and the at least one energy offer is available in the distributed ledger technology energy marketplace 132, the recommendation 128 of the time during the specified future time duration to buy the energy 124 from the distributed ledger technology energy marketplace 132.

According to examples disclosed herein, the trading recommender 126 may generate, based on the determined price 122 of the energy 124 for each specified divided future time duration of the plurality of specified divided future time durations, the recommendation 128 by determining, for the price 122 of energy 124 determined at each specified divided future time duration of the plurality of specified divided future time durations, a specified divided future time duration for which the price 122 of energy 124 is maximum. Further, the trading recommender 126 may generate, for the specified divided future time duration for which the price 122 of energy 124 is maximum, the recommendation 128 of the another time during the specified future time duration to sell the energy 124 to the distributed ledger technology energy marketplace 132.

According to examples disclosed herein, the trading recommender 126 may generate, based on the determined price 122 of the energy 124 for each specified divided future time duration of the plurality of specified divided future time durations, the recommendation 128 by determining, for the price 122 of energy 124 determined at each specified divided future time duration of the plurality of specified divided future time durations, a specified divided future time duration for which the price 122 of energy 124 is maximum and at least one energy demand is available in the distributed ledger technology energy marketplace 132. Further, the trading recommender 126 may generate, for the specified divided future time duration for which the price 122 of energy 124 is maximum and the at least one energy demand is available in the distributed ledger technology energy marketplace 132, the recommendation of the another time during the specified future time duration to sell the energy 124 to the distributed ledger technology energy marketplace 132.

Operation of the apparatus 100 described in further detail with reference to FIGS. 1-14.

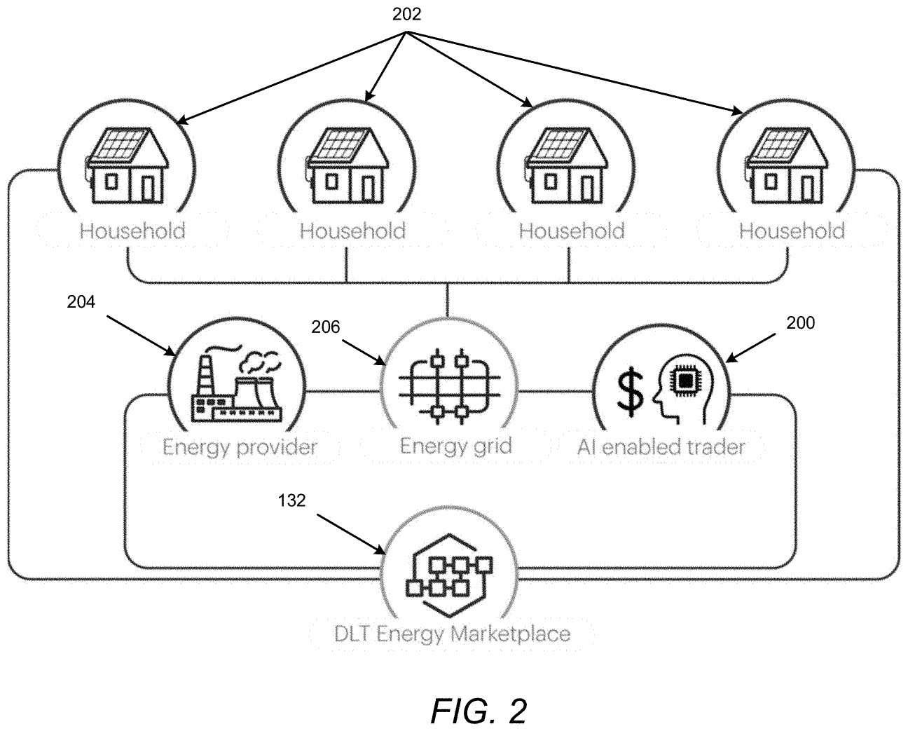

FIG. 2 illustrates an energy trading layout to illustrate operation of the apparatus 100 of FIG. 1 in accordance with an example of the present disclosure.

Referring to FIG. 2, a user 200 (e.g., a trader) may buy energy 124 from one or more households 202 (e.g., units, or other entities, as disclosed herein), and sell the energy 124 back to an energy provider 204. The user 200 may understand what is the best time to buy and sell the energy 124, for example, to an energy grid 206. The trading of the energy may be performed in the distributed ledger technology energy marketplace 132.

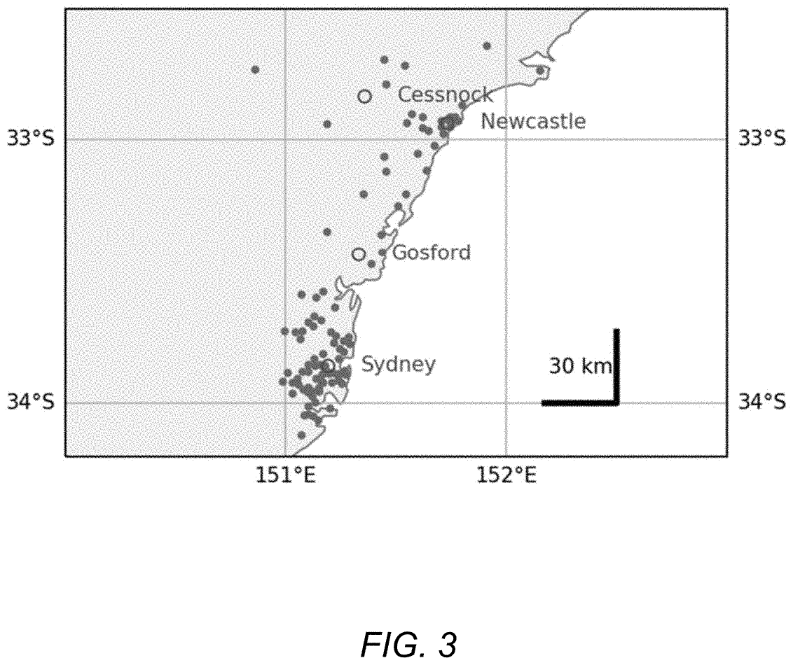

FIG. 3 illustrates a data source example to illustrate operation of the apparatus 100 of FIG. 1 in accordance with an example of the present disclosure.

Referring to FIG. 3, for the examples of operation of the apparatus 100 disclosed herein, the energy data 104 may be obtained, for example, from an Australian energy market and weather data. For example, the energy data 104 may be for 300 randomly selected homes (e.g., units, or other entities as disclosed herein) with rooftop solar systems that may be measured by a gross meter that records the total amount of solar power generated every 30 minutes. The energy data 104 may be sourced from the 300 randomly selected homes that utilize a gross metered solar system for the period of Jul. 1, 2010 to Jun. 30, 2013.

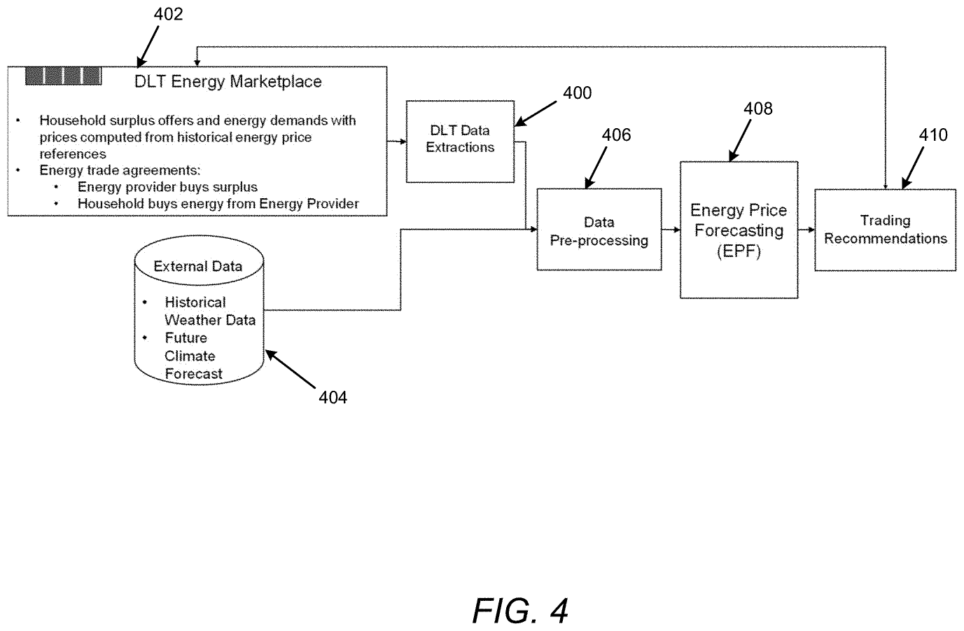

FIG. 4 illustrates a logical flow of the apparatus 100 of FIG. 1 in accordance with an example of the present disclosure.

Referring to FIG. 4, at 400, the energy data analyzer 102 may perform data extraction with respect to the distributed ledger technology energy marketplace 132 at 402. The distributed ledger technology energy marketplace 132 at 402 may be designated as the location to buy/sell energy, but may not be directly connected to an energy grid. The distributed ledger technology energy marketplace 132 may be used to extract the distributed ledger technology energy marketplace data 110 that may include household surplus offers and energy demands with prices determined from historical energy price references. The household surplus offers and energy demands may be associated with houses (e.g., units, or generally other entities that utilize energy) that are connected to a distributed ledger, and have agreed to sell surplus energy (e.g., provided from solar panels installed on the houses), and buy energy from the energy provider. For example, the distributed ledger technology energy marketplace data 110 may include energy trade agreements that specify, for example, logistics related to how an energy provider buys surplus, and logistics related to how a household buys energy from an energy provider.

At 404, external data that includes historical weather data 106, and future climate forecast data 108, may be forwarded to an energy data pre-processor 112 at 406.

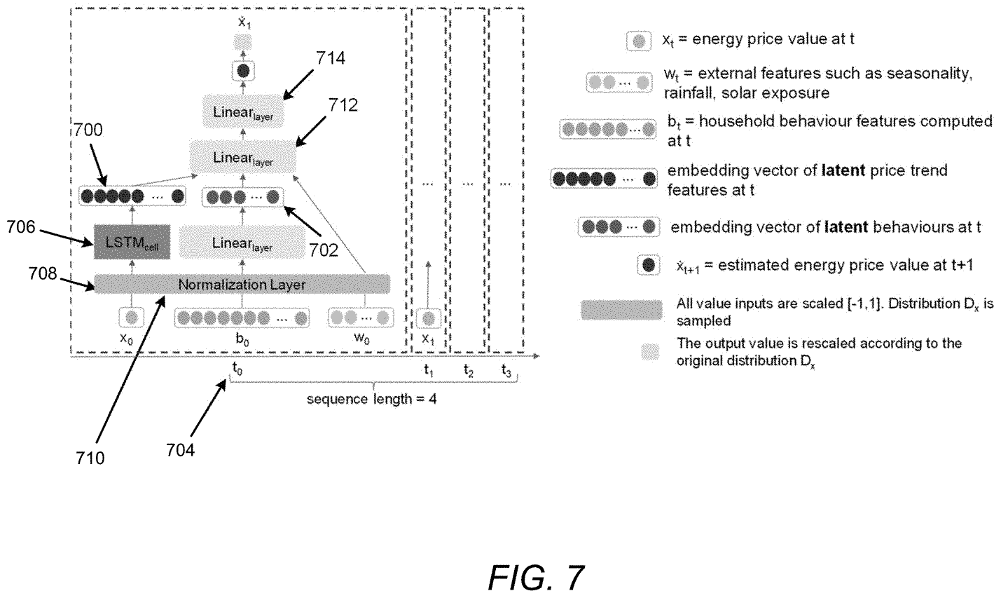

At 406, the energy data pre-processor 112 may pre-process the ascertained energy data 104 (that includes the historical weather data 106, future climate forecast data 108, and distributed ledger technology energy marketplace data 110) to generate pre-processed energy data 114. The ascertained energy data 104 may be mapped into a tri-dimensional data structure, named data frame, that may be manipulated by the energy data-preprocessor 112 utilizing the following procedural routines: 1) data merge and harmonization pivoting the timestamp as unique data frame index; 2) data inference for the computation of seasonal data such as day of the week as reported in FIG. 7; 3) data selection according to a given price and a given geographical area; and 4) data ascending sort according to timestamp.

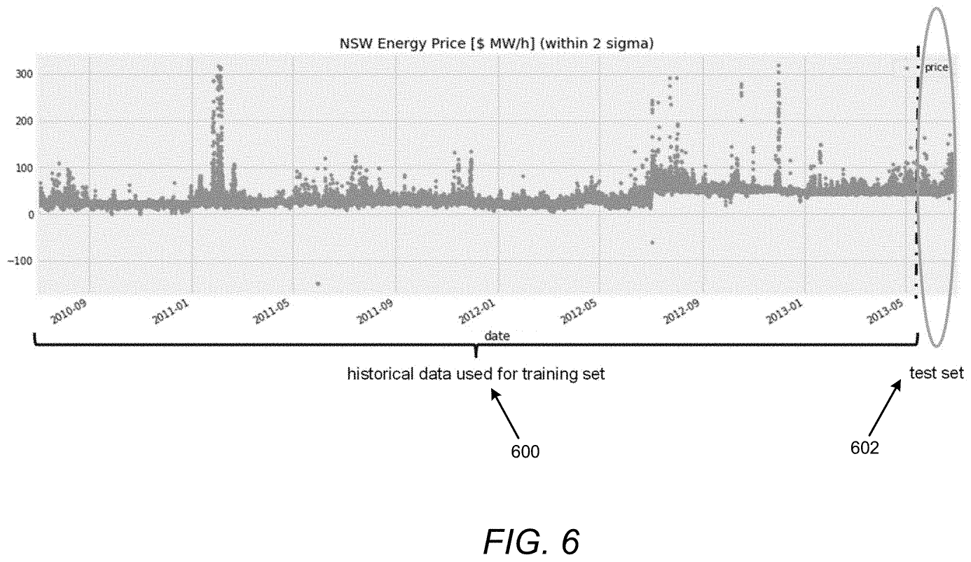

At 408, the energy price forecaster 116 may determine, based on the pre-processed energy data 114, a price 122 of energy 124. In this regard, the energy price forecaster 116 may utilize existing data to build, as disclosed herein with respect to FIGS. 6-10, a model to determine, based on the pre-processed energy data 114, the price 122 of energy 124.

At 410, the trading recommender 126 may generate, based on the determined price 122 of the energy 124, the recommendation 128 of a time 130 (e.g., buy time) to buy the energy from the distributed ledger technology energy marketplace 132, and/or another time 134 (e.g., sell time) to sell the energy 124 to the distributed ledger technology energy marketplace 132.

From 410 to 402, the distributed ledger technology energy marketplace controller 140 may update, based on the instructions 138 to implement the recommendation 128 to buy the energy 124 or sell the energy 124, the distributed ledger technology energy marketplace 132 to include, in the distributed ledger technology energy marketplace data 110, an amount of the energy 124 (e.g., that is bought or sold), and the price of the energy 124.

FIG. 5 illustrates a distributed ledger technology solidity smart contract model to illustrate operation of the apparatus 100 of FIG. 1 in accordance with an example of the present disclosure.

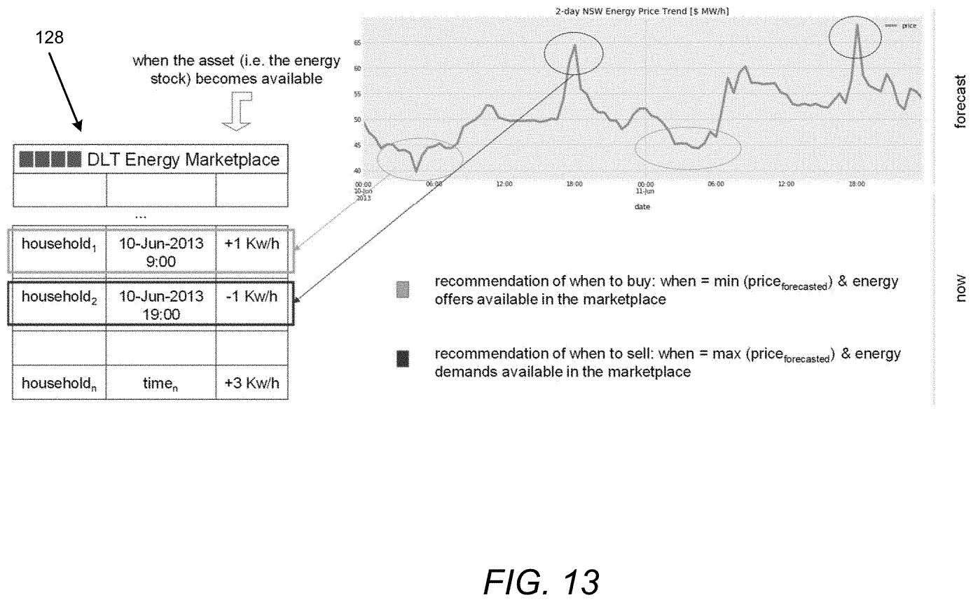

Referring to FIG. 5, the update trader at 500 may represent a link between the trading recommendation and the distributed ledger technology as disclosed herein with reference to FIG. 13. FIG. 5 may represent an example of the energy marketplace data structure. The information represented in FIG. 5 may include the minimum information required to store buy and sell offers in the distributed ledger technology energy marketplace 132. The structure of FIG. 5 may be designed for an Ethereum Smart Contract technology, where a different ledger may need a different implementation and representation of the data structure. Due to the storage capabilities of the Ethereum Smart Contract, paging may be utilized to distribute the data in multiple Smart Contracts denoted Storage as shown in FIG. 5. The orchestration of this distribution may be handled by a Smart Contract called Storage Factory as shown in FIG. 5. The Storage Factory may store a sequential list of Storages. Once a Storage is full, a new one may be automatically instantiated. The Storage Factory may also implement the logic to retrieve data. Therefore, to store energy data, a user may send a transaction to the Storage Factory that will manage its storage in the ledger. Further, the energy data analyzer 102 or the energy price forecaster 116 may retrieve stored energy data, by identification (ID) or timestamps, through the Storage Factory.

FIG. 6 illustrates the dataset division in a training set and a test set utilized for training the deep learning energy price forecaster of the apparatus 100 of FIG. 1 in accordance with an example of the present disclosure.

Referring to FIG. 6, with respect to energy price forecasting by the energy price forecaster 116, the energy price forecaster 116 may utilize historical energy price data for a training set. For example, the historical energy price data may be specified as shown at 600, and test energy price data may be specified as shown at 602. The energy price forecaster 116 may execute a learning process that iteratively minimizes the mean squared error (MSE) on the historical energy price data as shown at 600, and is evaluated on energy price data as shown at 602 not utilized for the training procedure. For the energy price forecasting, price forecasting may be performed according to weather forecast (e.g., rainfall, solar exposure), date and seasonality information, and household behavior (derived from surplus and deficit information stored on the distributed ledger technology) as disclosed herein with respect to FIG. 7. According to the example of FIG. 6, the energy price forecasting may be performed, for example, at 30-minute forecasting intervals for two days ahead. For example, the 30-minute may represent the specified time interval 118, and the two days may represent the specified future time duration 120. The quality of forecasting may be measured as estimated price value versus observed price value.

FIG. 7 illustrates deep learning technique for electricity price forecasting (EPF) to illustrate operation of the apparatus 100 of FIG. 1 in accordance with an example of the present disclosure.

Referring to FIG. 7, the energy price forecaster 116 may implement deep learning for electricity price forecasting by utilizing long short-term memory (LSTM) for modeling sequential information (e.g., explicit and implicit) throughout a time series. For FIG. 7, xₜ may represent energy price value at time t, wₜ may represent external features such as seasonality (e.g., date, hour, day of week, quarter, month, year, day of year, day of month, week of year), rainfall (e.g., the amount of rain in millimeters), and solar exposure (e.g., the total solar energy falling on a horizontal surface). The values may be highest in clear sun conditions during the summer and lowest during winter or very cloudy days, and the values may be in MJ/m². Further, be may represent household behavior features computed at time t. Each household may contribute to the creation of two features each in bₜ, namely sur (reports the surplus in kW/h) and def (reports the deficit in kW/h). For example, for number of households that is equal to three hundred, in total there will be six hundred features in bₜ. Surplus values may be positive and deficit values may be negative. The embedding vector of latent price trend features at t may be specified at 700, and the embedding vector of latent behaviors at t may be specified at 702. Further, \dot{x}ₜ₊₁ may represent estimated energy price value at t+1, all value inputs may be scaled at the normalization layer between [−1, 1], Gaussian distribution Dₓ may be sampled, and the output value may be rescaled according to the original distribution Dₓ. For example, the inputs may be scaled as follows:

$${X}_{std} = \frac{X - {X}_{min}}{{X}_{max} - {X}_{min}}$$

$${X}_{scaled} = {X}_{std} * ( max - min ) + min$$

$$where min , max = ( - 1 , + 1 )$$

At 704, the energy price forecaster 116 may divide, based on a specified time interval 118 (e.g., 30 minutes), a specified future time duration 120 (e.g., two days) to generate a plurality of specified divided future time durations (e.g., time durations associated with times t₁, t₂, etc.). The energy price forecaster 116 may determine, based on the pre-processed energy data 114 and for each specified divided future time duration of the plurality of specified divided future time durations, a price 122 (e.g., \dot{x}ₜ₁, \dot{x}ₜ₂, etc.), of energy 124.

For example, the energy price forecaster 116 may determine, based on the pre-processed energy data 114 (e.g., normalized energy data 114) and for each specified divided future time duration of the plurality of specified divided future time durations (e.g., time durations t₁, t₂, etc.), the price 122 of energy 124 by receiving, by a long short-term memory cell at 706, the price of the energy 124 at a specified time (e.g., x₀ at time t₀). The energy price forecaster 116 may determine, by the long short-term memory cell and based on the price of the energy 124 at the specified time, an embedding vector of price trend features (e.g., at 700) at the specified time.

At 708, all value inputs may be scaled by the energy data pre-processor 112 at the normalization layer, for example, between [−1, 1].

Further, the energy price forecaster 116 may determine, based on the pre-processed energy data 114 and for each specified divided future time duration of the plurality of specified divided future time durations, the price 122 of energy 124 by receiving, by a linear layer at 710, behavior features (e.g., bₜ) for each of the units at the specified time (t). The energy price forecaster 116 may determine, by the linear layer and based on the behavior features for each of the units at the specified time, an embedding vector of behaviors (e.g., at 702) at the specified time.

Further, the energy price forecaster 116 may determine, based on the pre-processed energy data and for each specified divided future time duration of the plurality of specified divided future time durations, the price 122 of energy 124 by receiving, by a further linear layer at 712, external features (e.g., wₜ) for each of the units (e.g., households) at the specified time (e.g., t). The external features may include, for example, seasonality, rainfall, and solar exposure. The energy price forecaster 116 may determine, based on the further linear layer, and based on the embedding vector of price trend features at the specified time and the embedding vector of behaviors at the specified time, the estimate of the price 122 (e.g., \dot{x}ₜ₊₁) of the energy 124 at the another specified time (e.g., t₁) during the specified future time duration 120.

At linear layer 714, the energy price forecaster 116 may be configured to utilize the resulting embedding of 712 to be mapped to the normalized estimated energy price value.

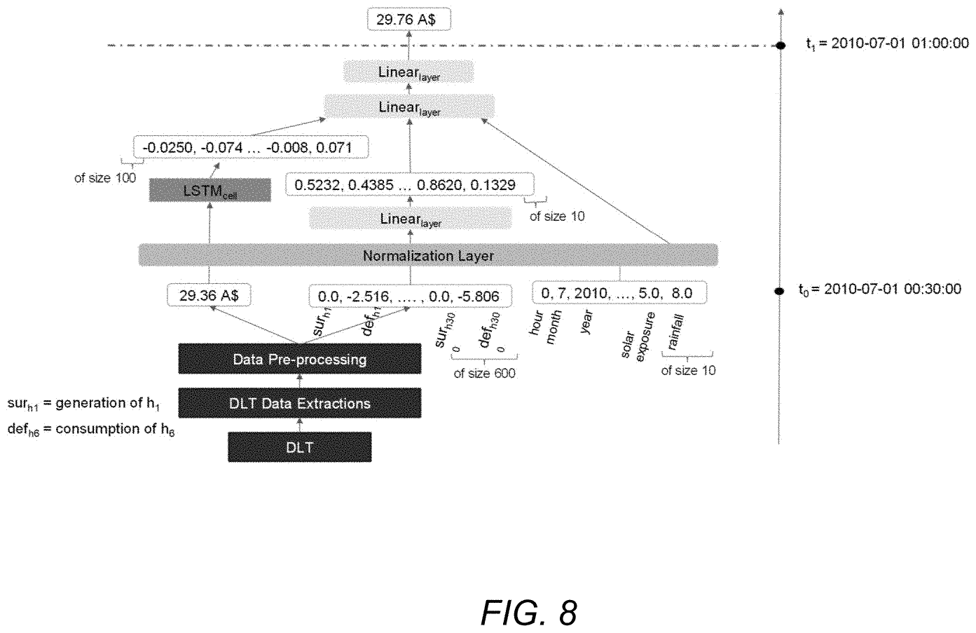

FIG. 8 illustrates execution of the deep learning technique over two time steps of a given time series for electricity price forecasting to illustrate operation of the apparatus 100 of FIG. 1 in accordance with an example of the present disclosure.

Referring to FIG. 8, for the first option of the deep learning technique for electricity price forecasting, for the price x₀ of $29.36 of the energy 124 at a specified time t₀ (e.g., Jul. 1, 2010 00:30:00), the energy price forecaster 116 may determine the price x₁ as $29.76 at the next specified time t₁ (e.g., Jul. 1, 2010 of 01:00:00) during a specified future time duration 120 corresponding to time t₁.

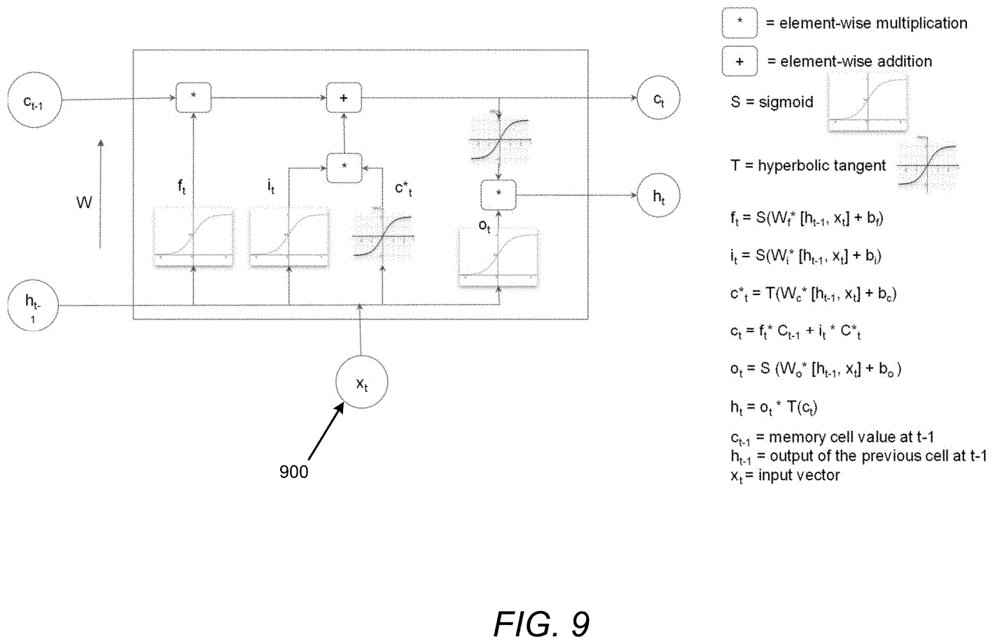

FIG. 9 illustrates long short-term memory cell for the apparatus 100 of FIG. 1 in accordance with an example of the present disclosure.

Referring to FIG. 9, a long short-term memory cell, such as the long short-term memory cell at 706 of FIG. 7, may include an input for the price xₜ at 900 of the energy 124 at the specified time (e.g., t). The energy price forecaster 116 may determine, by the long short-term memory cell and based on the price of the energy 124 at the specified time, an embedding vector of price trend features (e.g., at 700 of FIG. 7) at the specified time. The long short-term memory cell may represent an implementation of Recurrent Neural Networks (RNNs), where this deep learning structure may include a hidden state (hₜ₋₁) that is passed to the next step of the sequence data, recursively. In that case, hidden states act as the neural network memory. The core concepts of long short-term memory cell implementation may include the cell state (c) and the gates (f), where the cell state goal is to transport the information all the way down the sequence chain (xₜ). As the cell state goes on its journey, information gets added or removed to the cell state via gates, where they can learn what information is relevant to keep or forget during training. This operation is performed by the activation functions, where for long short-term memory cell, there are both sigmoid and hyperbolic tangent (Tanh) activation functions. First, the forget gate may decide what information should be discarded or retained. Information from the previous hidden state (hₜ₋₁) and information from the past cell (cₜ₋₁) may be passed through the sigmoid function, determining a value between 0 and 1, where the closer to 0 means to forget, and the closer to 1 means to keep. Second, information may be passed through both sigmoid and Tanh activation functions, where the result of the product of these decides which information is important to retain. Third, the new cell state may be determined by multiplying the input state from the previous point and the information filtered by the forget gate, which gives the new cell state. Finally, the output gate may decide what the next hidden state should be. The hidden state may also be used for predictions. In order to determine this hidden state, the previous hidden state and the current input may be passed into a sigmoid function, and then the newly modified cell state may be passed to the Tanh function. The Tanh output may be multiplied with the sigmoid output to decide what information the hidden state should carry, where the output is the hidden state. The new cell state and the new hidden state may then be carried over to the next time step. Each gate (f) may be subject to the sum of a scalar value also called bias (b) that defines the y-intercept, and the weights (W) may be utilized for defining the slope of the linear function. The size of W may depend on the size of the input embedding vector.

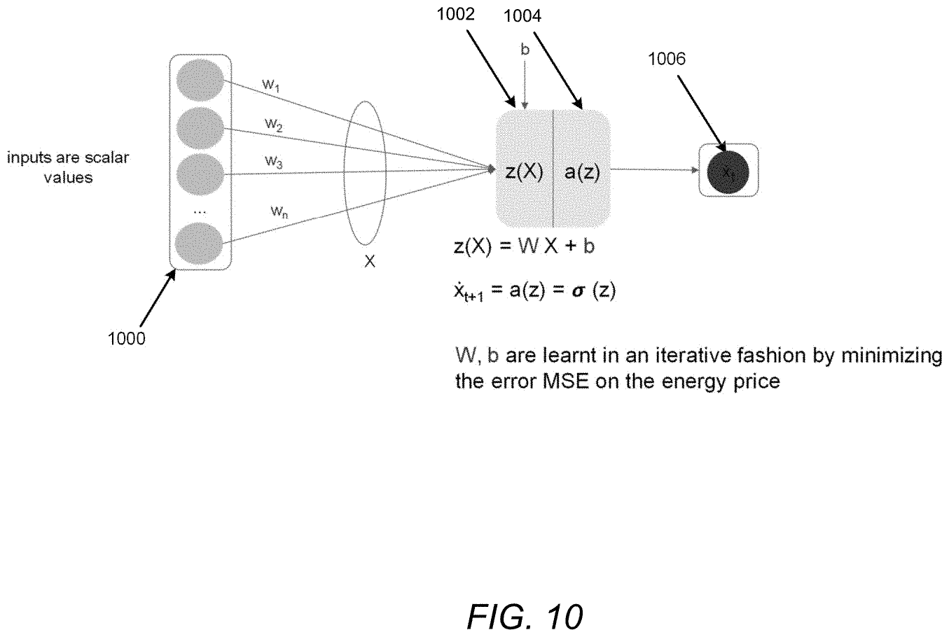

FIG. 10 illustrates a linear layer for the apparatus 100 of FIG. 1 in accordance with an example of the present disclosure.

Referring to FIG. 10, a linear layer, such as the linear layer at 710 may receive inputs that are scalar values at 1000. The linear layer may determine the functions z(X) at 1002 and a(z) at 1004 to determine \dot{x}ₜ₊₁ at 1006. In this regard, W (e.g., linear weights w; constituting the coefficient of the linear regression for the different Xₜ), and b may be learned in an iterative manner by minimizing the mean squared error (MSE) value. For each iteration, the error measured as MSE value may be back-propagated to the layer in order to tune the w; and b changing the inclination of the linear regression). Such an operation may be performed, for example, two thousand times as this value has been empirically verified to be optimal for the domain at analysis.

With respect to mean squared error (MSE) and key performance indicators (KPIs), the KPIs may include mean absolute error (MAE) and MSE. The mean absolute error may represent a measure of absolute difference between the results obtained (\dot{x}ᵢ) and the expected (xᵢ). The range may be [0−inf), with 0 being optimal, and n may represent the total number of results. The mean absolute error may be represented as follows:

$$MAE = \frac{{\sum }_{i = 1}^{n} \vert {\dot{x}}_{i} - {x}_{i} \vert}{n} \qquad Equation ( 1 )$$

The mean squared error may represent a measure of squared difference between the results obtained and expected, with the range being [0−inf), with 0 being optimal.

The mean squared error may be represented as follows:

$$MSE = \frac{{\sum }_{i = 1}^{n} {( {\dot{x}}_{i} - {x}_{i} )}^{2}}{n} \qquad Equation ( 2 )$$

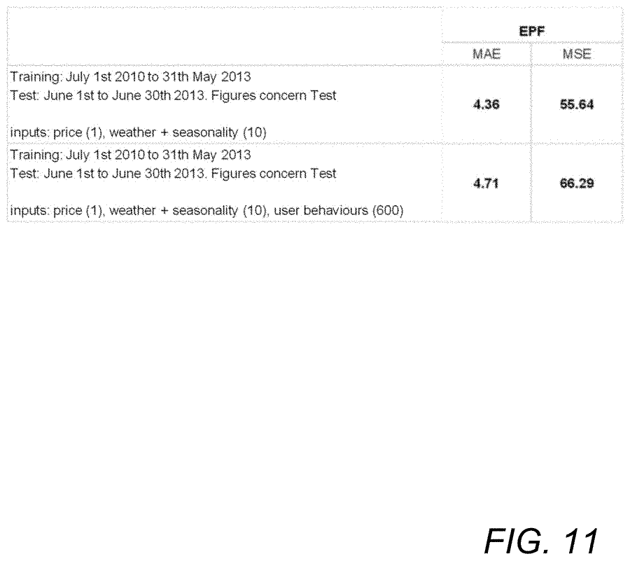

FIG. 11 illustrates electricity price forecasting validation results to illustrate operation of the apparatus 100 of FIG. 1 in accordance with an example of the present disclosure.

Referring to FIG. 11, with respect to electricity price forecasting validation, as disclosed herein with respect to FIG. 6, the experimental setup may including a training set from Jul. 1, 2010 to May 31, 2013, a validation set from Jun. 1, 2013 to Jun. 30, 2013, and input data that includes price, seasonality and rainfall (weather), solar exposure, and household behavior. In this regard, the mean absolute error without and with behavior (e.g., bₜ) factored in may be determined to be 4.36 and 4.71, respectively, and the mean squared error without and with behavior factored in may be determined to be 55.64 and 66.29, respectively.

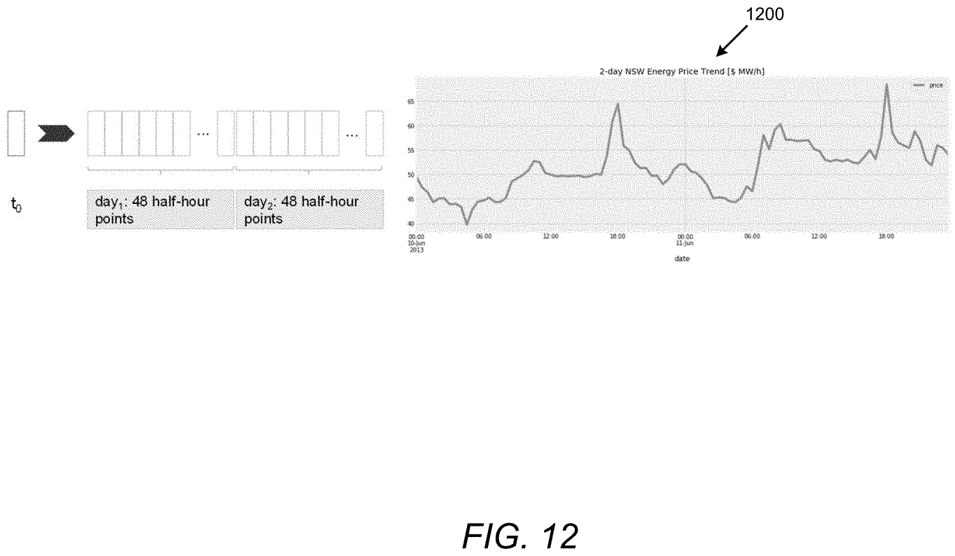

FIG. 12 illustrates trading recommendations to illustrate operation of the apparatus 100 of FIG. 1 in accordance with an example of the present disclosure.

Referring to FIG. 12, the trading recommendations may include, for the example of the specified time interval 118 of 30 minutes (e.g., see 704 of FIG. 7) and the specified future time duration 120 of two days, recommendations of when and what (e.g., buy or sell) based on two day electricity price forecasting. In this regard, variations in the price 122 for the two-day duration are shown at 1200.

FIG. 13 illustrates buy and sell recommendations to illustrate operation of the apparatus 100 of FIG. 1 in accordance with an example of the present disclosure.

Referring to FIG. 13, for the example of the specified time interval 118 of 30 minutes (e.g., see 704 of FIG. 7) and the specified future time duration 120 of two days of FIG. 12, the trading recommender 126 may generate, based on the determined price 122 of the energy 124 for each specified divided future time duration of the plurality of specified divided future time durations, a recommendation 128 of a time 130 (e.g., a buy time of Jun. 10, 2013 at 9:00 hrs.) during the specified future time duration to buy the energy 124 from a distributed ledger technology energy marketplace 132, and another time 134 (e.g., a sell time of Jun. 10, 2013 at 19:00 hrs.) during the specified future time duration 120 to sell the energy 124 to the distributed ledger technology energy marketplace 132. Buy and sell stocks may be determined according to the offerings at disposal in the marketplace at the time of the recommendation. In this regard, once the time has been identified, households may be selected according to their energy surpluses or deficits. When the request of buying or selling may be triggered, then households may be accommodated with a first in first served procedure that checks whether the need or offering satisfies the specified amount. This policy may identify multiple peaks (e.g., for both buying and selling) in the range of two days as defined in the implementation setup.

With respect to the trading controller 136, as disclosed herein, the trading controller 136 may generate, based on the recommendation of the time to buy the energy 124, and/or sell the energy 124, instructions 138 to implement the recommendation to buy the energy and/or sell the energy. In this regard, households may add new data to the distributed ledger technology energy marketplace 132 every day (or at another specified interval) logging in the consumed and the generated energy. In this regard, the distributed ledger technology energy marketplace controller 140 may update the distributed ledger technology energy marketplace 132 with the electricity price forecasting with new data regularly. If a trader confirms and/or issues a transaction, the distributed ledger technology energy marketplace 132 may be updated with the action, the amount of energy, and the price. For example, household-1 has an average surplus of 7 kW/h every day. A trader issues a transaction to buy 5 kwh electricity from household-1 the next day at 8:00 am (e.g., best time to buy). From 8:00 am the next day, the future prediction by the energy price forecaster 116 may take into account the fact that household-1 has sold electricity.

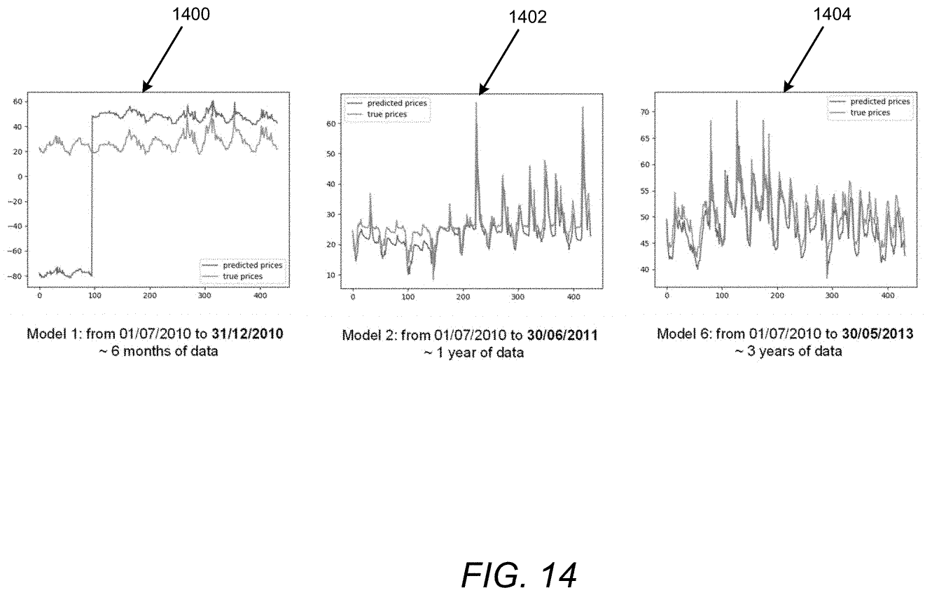

FIG. 14 illustrates correlation between data quantity and performance to illustrate operation of the apparatus 100 of FIG. 1 in accordance with an example of the present disclosure.

Referring to FIG. 14, the y-axis of each of the graphs of FIG. 14 may represent AUS $ (or another currency), and the x-axis may represent 30-minute intervals (or another specified time interval 118). In this regard, the electricity price forecasting by the energy price forecaster 116 may lead to behaviors such as estimation of negative prices due to a shortage of historical data utilized as training as shown at 1400, and thus resulting in drawbacks related to convergence. Further, a higher amount of data, as shown with respect to the graphs at 1400, 1402, and 1404, may also increase a precision of the electricity price forecasting. For example, it can be seen that the model for the graph at 1404 that utilizes three years of training data, the predicted prices by the energy price forecaster 116 more closely follow the true prices, compared to the graphs at 1400 and 1402 that respectively utilize 6 months and one year of training data.

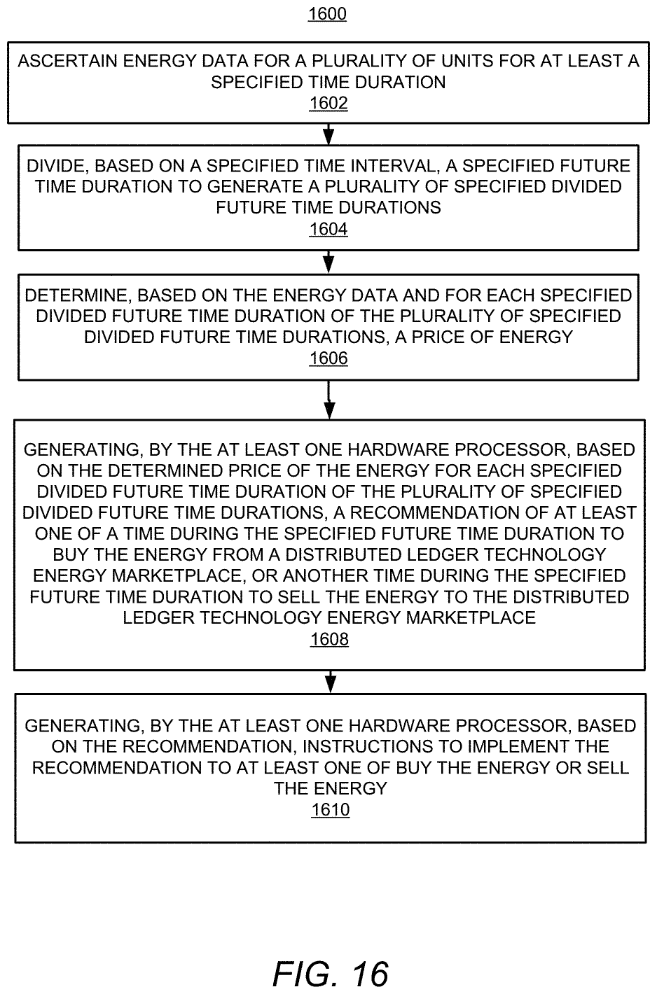

FIGS. 15-17 respectively illustrate an example block diagram 1500, a flowchart of an example method 1600, and a further example block diagram 1700 for distributed ledger technology and artificial intelligence-based energy trading, according to examples. The block diagram 1500, the method 1600, and the block diagram 1700 may be implemented on the apparatus 100 described above with reference to FIG. 1 by way of example and not of limitation. The block diagram 1500, the method 1600, and the block diagram 1700 may be practiced in other apparatus. In addition to showing the block diagram 1500, FIG. 15 shows hardware of the apparatus 100 that may execute the instructions of the block diagram 1500. The hardware may include a processor 1502, and a memory 1504 storing machine readable instructions that when executed by the processor cause the processor to perform the instructions of the block diagram 1500. The memory 1504 may represent a non-transitory computer readable medium. FIG. 16 may represent an example method for distributed ledger technology and artificial intelligence-based energy trading, and the steps of the method. FIG. 17 may represent a non-transitory computer readable medium 1702 having stored thereon machine readable instructions to provide distributed ledger technology and artificial intelligence-based energy trading according to an example. The machine readable instructions, when executed, cause a processor 1704 to perform the instructions of the block diagram 1700 also shown in FIG. 17.

The processor 1502 of FIG. 15 and/or the processor 1704 of FIG. 17 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1702 of FIG. 17), such as hardware storage devices (e.g., RAM (random access memory), ROM (read only memory), EPROM (erasable, programmable ROM), EEPROM (electrically erasable, programmable ROM), hard drives, and flash memory). The memory 1504 may include a RAM, where the machine readable instructions and data for a processor may reside during runtime.

Referring to FIGS. 1-15, and particularly to the block diagram 1500 shown in FIG. 15, the memory 1504 may include instructions 1506 to ascertain energy data 104. For example, the energy data 104 may include historical weather data 106 associated with a geographic region that includes a plurality of units that supply surplus energy to an energy provider and buy available energy from the energy provider. The energy data 104 may further include future climate forecast data 108 associated with the geographic region for at least a specified time duration. Further, the energy data 104 may include, for the units, distributed ledger technology energy marketplace data 110 that includes surplus energy offers and energy demands with prices.

The processor 1502 may fetch, decode, and execute the instructions 1508 to pre-process the ascertained energy data 104 to generate pre-processed energy data 114.

The processor 1502 may fetch, decode, and execute the instructions 1510 to divide, based on a specified time interval 118, a specified future time duration 120 to generate a plurality of specified divided future time durations.

The processor 1502 may fetch, decode, and execute the instructions 1512 to determine, based on the pre-processed energy data 114 and for each specified divided future time duration of the plurality of specified divided future time durations, a price 122 of energy 124.

The processor 1502 may fetch, decode, and execute the instructions 1514 to generate, based on the determined price 122 of the energy 124 for each specified divided future time duration of the plurality of specified divided future time durations, a recommendation 128 of a time 130 (e.g., a buy time) during the specified future time duration to buy the energy 124 from a distributed ledger technology energy marketplace 132 and/or another time 134 (e.g., a sell time) during the specified future time duration 120 to sell the energy 124 to the distributed ledger technology energy marketplace 132.

The processor 1502 may fetch, decode, and execute the instructions 1516 to generate, based on the recommendation 128, instructions 138 to implement the recommendation 128 to buy the energy 124 or sell the energy 124.

Referring to FIGS. 1-15 and 16, and particularly FIG. 16, for the method 1600, at block 1602, the method may include ascertaining, by at least one hardware processor, energy data 104 for a plurality of units for at least a specified time duration.

At block 1604, the method may include dividing, by the at least one hardware processor, based on a specified time interval 118, a specified future time duration 120 to generate a plurality of specified divided future time durations.

At block 1606, the method may include determining, by the at least one hardware processor, based on the energy data 104 and for each specified divided future time duration of the plurality of specified divided future time durations, a price 122 of energy 124.

At block 1608, the method may include generating, by the at least one hardware processor, based on the determined price 122 of the energy for each specified divided future time duration of the plurality of specified divided future time durations, a recommendation 128 of at least one of a time during the specified future time duration 120 to buy the energy from a distributed ledger technology energy marketplace 132, or another time during the specified future time duration 120 to sell the energy to the distributed ledger technology energy marketplace 132.

At block 1610, the method may include generating, by the at least one hardware processor, based on the recommendation 128, instructions to implement the recommendation 128 to at least one of buy the energy 124 or sell the energy 124.

Referring to FIGS. 1-15 and 17, and particularly FIG. 17, for the block diagram 1700, the non-transitory computer readable medium 1702 may include instructions 1706 to ascertain, energy data 104 for at least a specified time duration.

The processor 1704 may fetch, decode, and execute the instructions 1708 to divide, based on a specified time interval 118, a specified future time duration 120 to generate a plurality of specified divided future time durations.

The processor 1704 may fetch, decode, and execute the instructions 1710 to determine, based on the energy data 104 and for each specified divided future time duration of the plurality of specified divided future time durations, a price 122 of energy 124.

The processor 1704 may fetch, decode, and execute the instructions 1712 to generate, based on the determined price 122 of the energy for each specified divided future time duration of the plurality of specified divided future time durations, a recommendation 128 of at least one of a time during the specified future time duration 120 to buy the energy from a distributed ledger technology energy marketplace 132, or another time during the specified future time duration 120 to sell the energy to the distributed ledger technology energy marketplace 132.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A distributed ledger technology and artificial intelligence-based energy trading apparatus comprising:
an energy data analyzer, executed by at least one hardware processor, to
ascertain energy data that includes
historical weather data associated with a geographic region that includes a plurality of units that supply surplus energy to an energy provider and buy available energy from the energy provider,
future climate forecast data associated with the geographic region for at least a specified time duration, and
distributed ledger technology energy marketplace data that includes, for the units, surplus energy offers and energy demands with prices;
an energy data pre-processor, executed by the at least one hardware processor, to
pre-process the ascertained energy data to generate pre-processed energy data;
an energy price forecaster, executed by the at least one hardware processor, to
divide, based on a specified time interval, a specified future time duration to generate a plurality of specified divided future time durations, and
determine, based on the pre-processed energy data and for each specified divided future time duration of the plurality of specified divided future time durations, a price of energy;
a trading recommender, executed by the at least one hardware processor, to
generate, based on the determined price of the energy for each specified divided future time duration of the plurality of specified divided future time durations, a recommendation of at least one of
a time during the specified future time duration to buy the energy from a distributed ledger technology energy marketplace, or
another time during the specified future time duration to sell the energy to the distributed ledger technology energy marketplace; and
a trading controller, executed by the at least one hardware processor, to
generate, based on the recommendation, instructions to implement the recommendation to at least one of buy the energy or sell the energy.

2. The distributed ledger technology and artificial intelligence-based energy trading apparatus according to claim 1, wherein the energy data analyzer is executed by the at least one hardware processor to ascertain energy data that includes historical weather data associated with the geographic region that includes the plurality of units that supply surplus energy to the energy provider and buy available energy from the energy provider by:
ascertaining energy data that includes historical weather data associated with the geographic region that includes the plurality of units that each include a household.

3. The distributed ledger technology and artificial intelligence-based energy trading apparatus according to claim 1, wherein the energy price forecaster is executed by the at least one hardware processor to determine, based on the pre-processed energy data and for each specified divided future time duration of the plurality of specified divided future time durations, the price of energy by:
receiving, by a long short-term memory cell, the price of the energy at a specified time;
determining, by the long short-term memory cell and based on the price of the energy at the specified time, an embedding vector of price trend features at the specified time; and
determining, based on the embedding vector of price trend features at the specified time, an estimate of the price of the energy at another specified time during the specified future time duration.

4. The distributed ledger technology and artificial intelligence-based energy trading apparatus according to claim 3, wherein the energy price forecaster is executed by the at least one hardware processor to determine, based on the pre-processed energy data and for each specified divided future time duration of the plurality of specified divided future time durations, the price of energy by:
receiving, by a linear layer, behavior features for each of the units at the specified time;
determining, by the linear layer and based on the behavior features for each of the units at the specified time, an embedding vector of behaviors at the specified time; and
determining, based on the embedding vector of price trend features at the specified time and the embedding vector of behaviors at the specified time, the estimate of the price of the energy at the another specified time during the specified future time duration.

5. The distributed ledger technology and artificial intelligence-based energy trading apparatus according to claim 4, wherein the energy price forecaster is executed by the at least one hardware processor to determine, based on the pre-processed energy data and for each specified divided future time duration of the plurality of specified divided future time durations, the price of energy by:
receiving, by a further linear layer, external features for each of the units at the specified time, wherein the external features include at least one of seasonality, rainfall, or solar exposure; and
determining, based on the further linear layer, and based on the embedding vector of price trend features at the specified time and the embedding vector of behaviors at the specified time, the estimate of the price of the energy at the another specified time during the specified future time duration.

6. The distributed ledger technology and artificial intelligence-based energy trading apparatus according to claim 1, wherein the trading recommender is executed by the at least one hardware processor to generate, based on the determined price of the energy for each specified divided future time duration of the plurality of specified divided future time durations, the recommendation of at least one of the time during the specified future time duration to buy the energy from the distributed ledger technology energy marketplace, or another time during the specified future time duration to sell the energy to the distributed ledger technology energy marketplace by:
determining, for the price of energy determined at each specified divided future time duration of the plurality of specified divided future time durations, a specified divided future time duration for which the price of energy is minimum; and
generating, for the specified divided future time duration for which the price of energy is minimum, the recommendation of the time during the specified future time duration to buy the energy from the distributed ledger technology energy marketplace.

7. The distributed ledger technology and artificial intelligence-based energy trading apparatus according to claim 1, wherein the trading recommender is executed by the at least one hardware processor to generate, based on the determined price of the energy for each specified divided future time duration of the plurality of specified divided future time durations, the recommendation of at least one of the time during the specified future time duration to buy the energy from the distributed ledger technology energy marketplace, or another time during the specified future time duration to sell the energy to the distributed ledger technology energy marketplace by:
determining, for the price of energy determined at each specified divided future time duration of the plurality of specified divided future time durations, a specified divided future time duration for which the price of energy is minimum and at least one energy offer is available in the distributed ledger technology energy marketplace; and
generating, for the specified divided future time duration for which the price of energy is minimum and the at least one energy offer is available in the distributed ledger technology energy marketplace, the recommendation of the time during the specified future time duration to buy the energy from the distributed ledger technology energy marketplace.

8. The distributed ledger technology and artificial intelligence-based energy trading apparatus according to claim 1, wherein the trading recommender is executed by the at least one hardware processor to generate, based on the determined price of the energy for each specified divided future time duration of the plurality of specified divided future time durations, the recommendation of at least one of the time during the specified future time duration to buy the energy from the distributed ledger technology energy marketplace, or another time during the specified future time duration to sell the energy to the distributed ledger technology energy marketplace by:
determining, for the price of energy determined at each specified divided future time duration of the plurality of specified divided future time durations, a specified divided future time duration for which the price of energy is maximum; and
generating, for the specified divided future time duration for which the price of energy is maximum, the recommendation of the another time during the specified future time duration to sell the energy to the distributed ledger technology energy marketplace.

9. The distributed ledger technology and artificial intelligence-based energy trading apparatus according to claim 1, wherein the trading recommender is executed by the at least one hardware processor to generate, based on the determined price of the energy for each specified divided future time duration of the plurality of specified divided future time durations, the recommendation of at least one of the time during the specified future time duration to buy the energy from the distributed ledger technology energy marketplace, or another time during the specified future time duration to sell the energy to the distributed ledger technology energy marketplace by:
determining, for the price of energy determined at each specified divided future time duration of the plurality of specified divided future time durations, a specified divided future time duration for which the price of energy is maximum and at least one energy demand is available in the distributed ledger technology energy marketplace; and
generating, for the specified divided future time duration for which the price of energy is maximum and the at least one energy demand is available in the distributed ledger technology energy marketplace, the recommendation of the another time during the specified future time duration to sell the energy to the distributed ledger technology energy marketplace.

10. The distributed ledger technology and artificial intelligence-based energy trading apparatus according to claim 1, further comprising:
a distributed ledger technology energy marketplace controller, executed by the at least hardware processor, to
update, based on the instructions to implement the recommendation to at least one of buy the energy or sell the energy, the distributed ledger technology energy marketplace to include, in the distributed ledger technology energy marketplace data, an amount of energy and the price of the energy.

11. A method for distributed ledger technology and artificial intelligence-based energy trading, the method comprising:
ascertaining, by at least one hardware processor, energy data for a plurality of units for at least a specified time duration;
dividing, by the at least one hardware processor, based on a specified time interval, a specified future time duration to generate a plurality of specified divided future time durations;
determining, by the at least one hardware processor, based on the energy data and for each specified divided future time duration of the plurality of specified divided future time durations, a price of energy;
generating, by the at least one hardware processor, based on the determined price of the energy for each specified divided future time duration of the plurality of specified divided future time durations, a recommendation of at least one of
a time during the specified future time duration to buy the energy from a distributed ledger technology energy marketplace, or
another time during the specified future time duration to sell the energy to the distributed ledger technology energy marketplace; and
generating, by the at least one hardware processor, based on the recommendation, instructions to implement the recommendation to at least one of buy the energy or sell the energy.

12. The method according to claim 11, wherein ascertaining, by the at least one hardware processor, the energy data for the plurality of units for at least the specified time duration further comprises:
ascertaining, by the at least one hardware processor, the energy data that includes
historical weather data associated with a geographic region that includes the plurality of units that supply surplus energy to an energy provider and buy available energy from the energy provider,
future climate forecast data associated with the geographic region for at least the specified time duration, and
distributed ledger technology energy marketplace data that includes, for the units, surplus energy offers and energy demands with prices.

13. The method according to claim 11, wherein determining, by the at least one hardware processor, based on the energy data and for each specified divided future time duration of the plurality of specified divided future time durations, the price of energy further comprises:
receiving, by the at least one hardware processor and by a long short-term memory cell, the price of the energy at a specified time;
determining, by the at least one hardware processor, by the long short-term memory cell, and based on the price of the energy at the specified time, an embedding vector of price trend features at the specified time; and
determining, by the at least one hardware processor, and based on the embedding vector of price trend features at the specified time, an estimate of the price of the energy at another specified time during the specified future time duration.

14. The method according to claim 13, wherein determining, by the at least one hardware processor, based on the energy data and for each specified divided future time duration of the plurality of specified divided future time durations, the price of energy further comprises:
receiving, by the at least one hardware processor and by a linear layer, behavior features for each of the units at the specified time;
determining, by the at least one hardware processor, by the linear layer, and based on the behavior features for each of the units at the specified time, an embedding vector of behaviors at the specified time; and
determining, by the at least one hardware processor, based on the embedding vector of price trend features at the specified time, and the embedding vector of behaviors at the specified time, the estimate of the price of the energy at the another specified time during the specified future time duration.

15. The method according to claim 14, wherein determining, by the at least one hardware processor, based on the energy data and for each specified divided future time duration of the plurality of specified divided future time durations, the price of energy further comprises:
receiving, by the at least one hardware processor and by a further linear layer, external features for each of the units at the specified time, wherein the external features include at least one of seasonality, rainfall, or solar exposure; and
determining, by the at least one hardware processor, based on the further linear layer, and based on the embedding vector of price trend features at the specified time and the embedding vector of behaviors at the specified time, the estimate of the price of the energy at the another specified time during the specified future time duration.

16. A non-transitory computer readable medium having stored thereon machine readable instructions, the machine readable instructions, when executed by at least one hardware processor, cause the at least one hardware processor to:
ascertain, energy data for at least a specified time duration;
divide, based on a specified time interval, a specified future time duration to generate a plurality of specified divided future time durations;
determine, based on the energy data and for each specified divided future time duration of the plurality of specified divided future time durations, a price of energy; and
generate, based on the determined price of the energy for each specified divided future time duration of the plurality of specified divided future time durations, a recommendation of at least one of
a time during the specified future time duration to buy the energy from a distributed ledger technology energy marketplace, or
another time during the specified future time duration to sell the energy to the distributed ledger technology energy marketplace.

17. The non-transitory computer readable medium according to claim 16, wherein the machine readable instructions, when executed by the at least one hardware processor, cause the at least one hardware processor to:
generate, based on the recommendation, instructions to implement the recommendation to at least one of buy the energy or sell the energy.

18. The non-transitory computer readable medium according to claim 16, wherein the machine readable instructions to determine, based on the energy data and for each specified divided future time duration of the plurality of specified divided future time durations, the price of energy, when executed by the at least one hardware processor, cause the at least one hardware processor to:
receive, by a long short-term memory cell, the price of the energy at a specified time;
determine, by the long short-term memory cell, and based on the price of the energy at the specified time, an embedding vector of price trend features at the specified time; and
determine, based on the embedding vector of price trend features at the specified time, an estimate of the price of the energy at another specified time during the specified future time duration.

19. The non-transitory computer readable medium according to claim 18, wherein the machine readable instructions to determine, based on the energy data and for each specified divided future time duration of the plurality of specified divided future time durations, the price of energy, when executed by the at least one hardware processor, cause the at least one hardware processor to:
receive, by a linear layer and for a plurality of units that are used to obtain the energy data, behavior features for each of the units at the specified time;
determine, by the linear layer, and based on the behavior features for each of the units at the specified time, an embedding vector of behaviors at the specified time; and
determining, based on the embedding vector of price trend features at the specified time, and the embedding vector of behaviors at the specified time, the estimate of the price of the energy at the another specified time during the specified future time duration.

20. The non-transitory computer readable medium according to claim 19, wherein the machine readable instructions to determine, based on the energy data and for each specified divided future time duration of the plurality of specified divided future time durations, the price of energy, when executed by the at least one hardware processor, cause the at least one hardware processor to:
receive, by a further linear layer, external features for each of the units at the specified time, wherein the external features include at least one of seasonality, rainfall, or solar exposure; and
determine, based on the further linear layer, and based on the embedding vector of price trend features at the specified time and the embedding vector of behaviors at the specified time, the estimate of the price of the energy at the another specified time during the specified future time duration.
